(19) United States
(12) Patent Application Publication
(10) Pub. No.: US 2023/0343369 A1
(43) Pub. Date: Oct. 26, 2023

(54) POST-CAPTURE MULTI-CAMERA EDITOR FROM AUDIO WAVEFORMS AND CAMERA LAYOUT

(71) Applicant: AutoPod LLC, St. Charles, MO (US)

(72) Inventor: Richard James Pfleging, St. Charles, MO (US)

(21) Appl. No.: 18/305,821

(22) Filed: Apr. 24, 2023

Related U.S. Application Data
(60) Provisional application No. 63/334,587, filed on Apr. 25, 2022.

(51) Int. Cl. G11B 27/06; G11B 27/036; G11B 27/34; H04N 5/268; G10L 25/57

(52) U.S. Cl. CPC G11B 27/06; G11B 27/036; G11B 27/34; H04N 5/268; G10L 25/57

(57) ABSTRACT

A system and method for editing a multi-camera video are provided. The method may include measuring an amplitude over a time interval for each of a plurality of audio tracks, determining a peak audio amplitude for the time interval among the plurality of audio tracks, assigning a classification to each of one or more cameras, selecting a first camera from the one or more cameras based on the classification assigned to each of the one or more cameras and the amplitude of a plurality of audio track; and generating a video such that the video is cut based on the camera selection.

### CROSS-REFERENCE TO RELATED APPLICATION

This application claims the benefit of the filing date of U.S. Provisional Application Ser. No. 63/334,587, filed Apr. 25, 2022, entitled, “Post-Capture Multi-Camera Editor From Audio Amplitudes and Camera Layout”, which is hereby incorporated by reference as if fully set forth herein.

### FIELD OF THE DISCLOSURE

This disclosure generally relates to video creation and editing. More specifically, this disclosure relates to automatically selecting appropriate cameras and generating video cuts in a multi-camera video.

### BACKGROUND OF THE DISCLOSURE

In the world of video editing, there are currently several ways to edit a multi-camera video. For instance, a multi-camera video can be edited by a person in post-production. However, human editing may take a large amount of time, often results in errors, and does not provide the best and smoothest possible result in identifying the ideal camera selections based on who, when, and how many people are speaking.

As another example, a multi-camera video may also be “live cut” with a person switching camera angles in real time. However, this method may result in even more errors than the human editing post-production and may be even worse at selecting the ideal camera.

In view of the forgoing, there is a need for an effective method in editing a multi-camera video while reducing error rates.

### BRIEF SUMMARY OF THE DISCLOSURE

An aspect of this disclosure pertains to an automated multi-camera video editor that utilizes the audio waveforms for each audio track and the camera layout for each video track to generate a complete post-capture edit.

A first aspect of this disclosure pertains to a method for editing a multi-camera video comprising measuring an amplitude over a time interval for each of a plurality of audio tracks; assigning a classification to each of one or more cameras; selecting a first camera from the one or more cameras based on the classification assigned to each of the one or more cameras and the amplitude of a plurality of audio track; and generating a video such that the video is cut based on the camera selection, wherein each of the plurality of audio tracks corresponds to one of a plurality of audio sources respectively, and each of the one or more cameras corresponds to at least one of the plurality of audio sources.

A second aspect of this disclosure pertains to the method of the first aspect, wherein the selecting the first camera further comprising determining a largest amplitude for the time interval among the plurality of audio tracks; and selecting a first audio track from the plurality of audio tracks wherein the first audio track has a largest amplitude at the time interval, and wherein the first camera corresponds to the first audio track.

A third aspect of this disclosure pertains to the method of the second aspect further comprising determining that the first audio track at the time interval includes an anomaly and selecting a second audio track from the plurality of audio tracks wherein the second audio track has a next largest amplitude at the time interval, wherein the first camera corresponds to the second audio track.

A fourth aspect of this disclosure pertains to the method of the third aspect, wherein the determining that the first audio track includes the anomaly further comprising comparing a first amplitude for the first audio track at the time interval against a second amplitude for the first audio track at an adjacent time interval.

A fifth aspect of this disclosure pertains to the method of the second aspect further comprising selecting the first camera based on a hierarchy of how many individuals are captured by the first camera during the time interval.

A sixth aspect of this disclosure pertains to the method of the first aspect further comprising determining an amplitude differential between two of the plurality of audio tracks at the time interval is within a first threshold, wherein the selecting the first camera further comprising selecting the first camera that correspond to both of the two of the plurality of audio tracks.

A seventh aspect of this disclosure pertains to the method of the first aspect further comprising converting the selecting of the first camera into an editing instruction for the video.

An eighth aspect of this disclosure pertains to the method of the first aspect, wherein the classification corresponds to an amount of audio tracks that each of the one or more cameras correspond to.

A ninth aspect of this disclosure pertains to a method for editing a multi-camera video comprising measuring an amplitude per time interval for each of a plurality of audio tracks over a length of a video; determining a first peak audio amplitude among the plurality of audio tracks for each time interval; creating a first array including the first peak audio amplitude among the plurality of audio tracks for each time interval; creating a second array including a camera selection for each time interval based on the first array; and generating the video such that the video is edited based on the second array.

A tenth aspect of this disclosure pertains to the method of the ninth aspect further comprising determining the first peak audio amplitude among the plurality of audio track at a time interval is an anomaly; and modifying the first array such that the first peak audio amplitude is replaced with a second peak audio amplitude at the time interval.

An eleventh aspect of this disclosure pertains to the method of the tenth aspect, wherein the determining that the first peak audio amplitude is the anomaly further comprising comparing the first peak amplitude at the time interval against a second amplitude for a same audio track at an adjacent time interval.

A twelfth aspect of this disclosure pertains to method of the ninth aspect, wherein the camera selected is further based on a hierarchy of how many individuals are captured by a camera during the time interval

A thirteenth aspect of this disclosure pertains to the method of the ninth aspect further comprising determining an amplitude differential between two of the plurality of audio tracks for each time interval; creating a third array for the amplitude differential; and modifying the second array based on the third array.

A fourteenth aspect of this disclosure pertains to the method of the ninth aspect further comprising determining whether the second array includes two over more different camera selections within a threshold period; and modifying the second array to extend a camera selection at a beginning of the threshold period throughout the threshold period by discarding other camera selections within the threshold period.

A fifteenth aspect of this disclosure pertains to the method of the ninth aspect further comprising determining whether the second array includes a first camera selection for a time period that exceeds a threshold amount; and modifying the second array to include a second camera selection different during the time period, wherein the second camera selection is different than the first camera selection.

A sixteenth aspect of this disclosure pertains to the method of the ninth aspect further comprising determining whether a first camera selection is utilized for a first time period and a second time period and whether an alternate camera selection is available to the first camera selection; and modifying the second array to include the alternate camera selection in lieu of the first camera selection for the second time period.

A seventeenth aspect of this disclosure pertains to the method of the sixteenth aspect, wherein the first camera selection and the alternate camera selection both include a same number of individuals captured by a camera.

An eighteenth aspect of this disclosure pertains to the method of the ninth aspect further comprising converting the second array into an editing instruction for the video.

A nineteenth aspect of this disclosure pertains to the method of the ninth aspect further comprising assigning a classification to each of one or more video tracks, wherein the classification corresponds to an amount of audio tracks that each of the one or more video tracks correspond to.

A twentieth aspect of this disclosure pertains to the method of the nineteenth aspect, wherein the camera selection for each time interval comprises a selection of a video track from the one or more video tracks for each time interval.

### BRIEF DESCRIPTION OF THE DRAWINGS

FIG. 1 illustrates a method for editing a video according to an embodiment.

FIG. 2 illustrates a plurality of audio measurements according to an embodiment.

FIG. 3 illustrates a first system according to an embodiment.

FIG. 4 illustrates an example layout for the first system of FIG. 3.

FIG. 5 illustrates a second system according to an embodiment.

FIG. 6 illustrates an example layout for the second system of FIG. 5.

FIG. 7 illustrates a third system according to an embodiment.

FIG. 8 illustrates an example layout for the third system of FIG. 7.

FIG. 9 illustrates a fourth system according to an embodiment.

FIG. 10 illustrates an example layout for the fourth system of FIG. 9.

FIG. 11 illustrates a fifth system according to an embodiment.

FIG. 12 illustrates a first example layout for the fifth system of FIG. 11.

FIG. 13 illustrates a second example layout for the fifth system of FIG. 11.

FIG. 14 illustrates a sixth system according to an embodiment.

FIG. 15 illustrates an example layout for the sixth system of FIG. 14.

FIG. 16 illustrates a method for a camera selection according to an embodiment.

Before explaining the disclosed embodiment of the present disclosure in detail, it is to be understood that the disclosure is not limited in its application to the details of the particular arrangement shown, since the disclosure is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this disclosure is susceptible of embodiments in many different forms, there are shown in the drawings and will be described in detail herein specific embodiments with the understanding that the present disclosure is an exemplification of the principles of the disclosure. It is not intended to limit the disclosure to the specific illustrated embodiments. The features of the disclosure disclosed herein in the description, drawings, and claims can be significant, both individually and in any desired combinations, for the operation of the disclosure in its various embodiments. Features from one embodiment can be used in other embodiments of the disclosure.

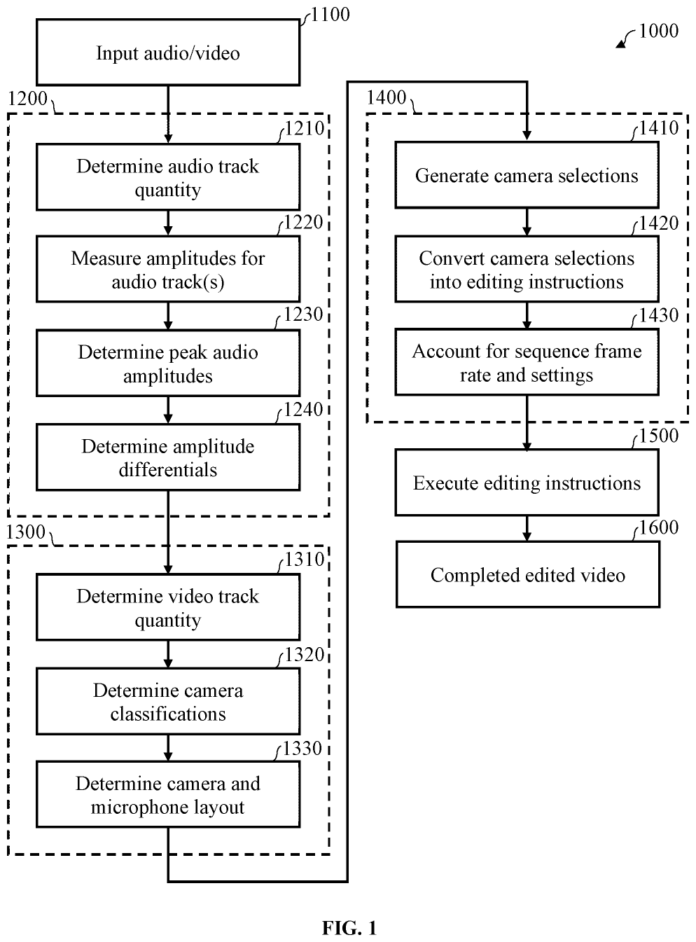

FIG. 1 illustrates a method 1000 for editing a video according to an embodiment. The method 1000 may be implemented by a device and/or a system. By way of example, the device may be a personal computer (PC), a laptop computer, a server, a mobile device (such as a cellular phone, a tablet, or the likes), or a combination thereof. In some embodiments, the method 1000 may be performed by one single device. In further embodiments, steps of the method 1000 may be performed across multiple devices in a distributed fashion. As can be appreciated, the device and/or system for implementing the method 1000 may include one or more processors coupled to one or more memories. The method 1000 may be programing instructions that may be executed by the one or more processors. In some embodiments, the method 1000 may be in the form of a software, an application, a plug-in, an add-on, or the likes. In further embodiments, the method 1000 may be implemented by a special-purpose machine suitable for video editing.

At step 1100, video and audio file(s) may be inputted into the system or device implementing the method 1000. An audio input may be a collection of audio files containing separate audio track for each audio source such as a microphone. For example, if a system setup includes one single audio source, the audio input may comprise one single audio file containing an audio track for the single audio source. If a system setup includes two audio sources, the audio input may comprise two single audio files each containing an audio track for a respective audio source. Likewise, if a system setup includes three audio sources, the audio input may comprise three audio files each containing an audio track for a respective audio source. It is to be appreciated that the audio input may be any number of audio tracks from any type of audio source.

The audio files may be stored in any location, either locally or remotely or a combination thereof, provided that the audio files may be accessed by the implementing system. In some embodiments, the audio files may be stored locally on one or more hard drives, thus, at step 1100, the implementing system may input audio by loading the audio files from the hard drives. In other embodiments, the audio files may be stored remotely on the Internet or on one or more network drives, thus, at step 1100, the implementing system may input audio by downloading the audio files over a network. In further embodiments, the audio input may be from one or more live feeds (in real-time or near real-time) from one or more audio sources. Audio files may be formatted as a WAV, MP3, MP4, MOV, or other suitable formats.

Similar to an audio input, a video input may be a collection of video files containing separate video track for each video source such as a camera. For example, if a system setup includes one single video source, the video input may comprise one single video file containing a video track for the single video source. If a system setup includes two video sources, the video input may comprise two video files each containing a video track for a respective video source. Likewise, if a system setup includes three video sources, the video input may comprise three video files each containing a video track for a respective video source. It is to be appreciated that the video input may be any number of video tracks from any type of video source.

Similar to audio files, the video files may be stored in any location, either locally or remotely or a combination thereof, provided that the video files may be accessed by the implementing system. In some embodiments, the video files may be stored locally on one or more hard drives, thus, at step 1100, the implementing system may input video by loading the video files from the hard drives. In other embodiments, the video files may be stored remotely on the Internet or on one or more network drives, thus, at step 1100, the implementing system may input video by downloading the audio files over a network. In further embodiments, the video input may be from one or more live feeds (in real-time or near real-time) from one or more video sources. video files may be formatted as a MP4, MOV, or other suitable formats.

Next, a process 1200 to analyze audio may be performed. The process 1200 may include a step 1210 to determine a number of audio tracks included in the audio input from step 1100. For instance, the number of audio tracks may be determined by counting a number of audio files included in the audio input. In further embodiments, the number of audio tracks may be determined by soliciting an input from a user. In yet some other embodiments, the number of audio tracks may be determined by a learned machine learning algorithm where the machine learning algorithm may be configured to separate audio tracks contained in an audio file.

At step 1220, an audio waveform may be generated using an audio analyzer that may be in the form of a software or hardware. From the generated waveform, measurements of audio amplitudes may be created along a length of an audio sequence. The measurements may be taken at a sample rate—that may be fixed or variable—for the full length of the audio track.

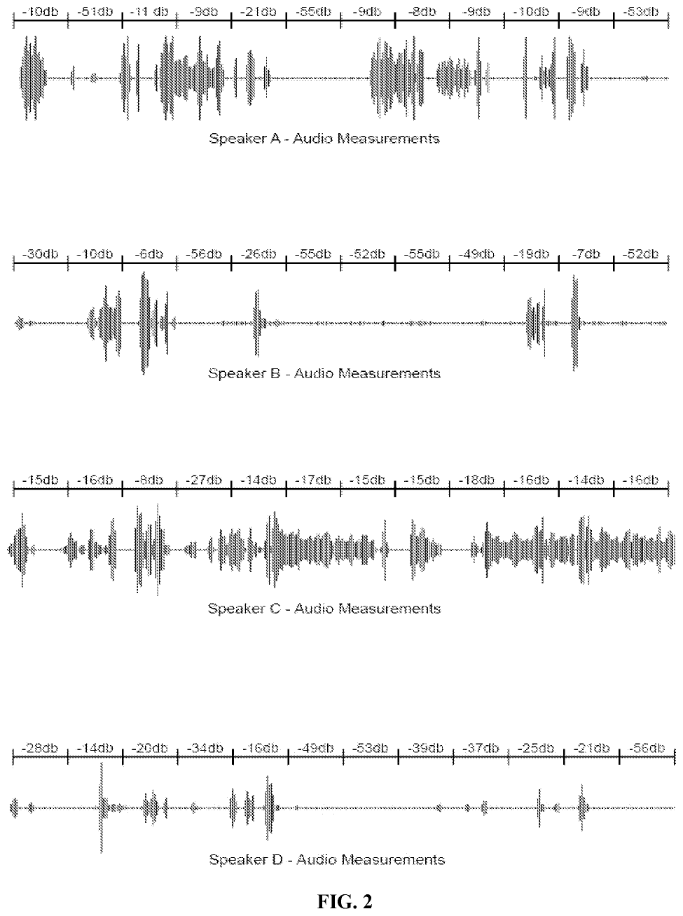

Examples of the measurements are illustrated in FIG. 2. As can be appreciated, examples in FIG. 2 illustrate only a portion of the overall measurements. For example, if amplitudes are measured at one second intervals (i.e., one measurement per second), an hour-long sequence thus may contain 3,600 amplitude measurements (60 seconds×60 minutes) for each audio track. If, for example, an embodiment utilizes four microphones as audio sources such that each microphone corresponds to a speaker (such as Speaker A, Speaker B, Speaker C, and Speaker D), measuring amplitudes at a frequency of once per second would generate 14,440 amplitude measurements (60 seconds×60 minutes×4 microphones). The measured values may be stored in a first array (amplitude array) to be analyzed. An array may be in the form of an array of values, a string of values, a set of values, a matrix, a spreadsheet, or other suitable formats.

In embodiments where higher precision is preferred, amplitudes may be measured at higher frequencies (i.e., smaller time intervals). Using the four-microphone example as above, if frequency is increased to one measurement per 0.1 second, 36,000 amplitudes may be measured per track or 144,400 total measurements for this case (60 seconds×60 minutes×10 readings per second×4 microphones). Audio amplitudes may be measured in decibels (db) or other suitable units. The measurements may be taken throughout an entire length of a track or a portion of a track.

Returning to FIG. 1, at step 1230, after audio amplitudes are measured, each audio track's amplitude may be compared throughout an entire duration, timeline, and/or intervals to calculate a peak amplitude which may correspond to a largest (maximum) or lowest (minimum) amplitude value. For example, at time T₀, the amplitude for track one may be the highest, whereas at time T₁, the amplitude for track two may be the highest, and so forth.

Using the 0.1 second measurement interval discussed about, 36,000 peak amplitude values may be selected, one for each of the 36,000 intervals. The peak amplitude for each interval may be stored in a second array (peak amplitude array). The associated audio track for each 0.1 second interval across the 36,000 peak amplitudes may also be stored in a third array (audio array).

At step 1240, differentials between each amplitude may be calculated for each interval as an additional data point to be used. One or more fourth arrays (comparison arrays) may be created to store each differential set. Returning to the four microphones example, amplitude differentials may be calculated between combinations of pairs of microphones-resulting in six fourth arrays, a first fourth array for Speaker A and B, a second fourth array for Speaker A and C, a third fourth array for Speaker A and D, a fourth fourth array for Speaker B and C, a fifth fourth array for Speaker B and D, and a sixth fourth array for Speaker C and D, where each fourth array may include 36,000 values comparing amplitudes between the two microphone pairs.

A process 1300 to analyze video may also be performed. The process 1300 may include a step 1310 to determine a number of video tracks included in the video input from step 1100. For instance, the number of video tracks may be determined by counting a number of video files included in the video input. In further embodiments, the number of video tracks may be determined by soliciting an input from a user. In yet some other embodiments, the number of video tracks may be determined by a learned machine learning algorithm.

At step 1320, camera classifications may be determined. A classification for each camera may correspond to one or more audio sources that are linked with the camera. In some embodiments, a classification may be determined by a machine learning module configured to determine a number of persons or speakers included in a frame of a video.

Some example classifications may include: a “single shot” contains one person in the frame of a respective video; an “alternate single shot” contains the same person in the frame of a respective video but from a different angle; a “two shot” contains two people in the frame of a respective video; an “alternate two shot” contains the same two people in the frame of a respective video but from a different angle; a “three shot” contains three people in the frame of a respective video; an “alternate three shot” contains the same three people in the frame of a respective video but from a different angle; a “four shot” contains four people in the frame of a respective video; an “alternate four shot” contains the same four people in the frame of a respective video but from a different angle; and so forth. Additional classifications may include: a “wide shot” contains all the people in any other shots in the frame of a respective video; or an “alternate wide shot” contains all the people in any other shots in the frame of a respective video but from a different angle.

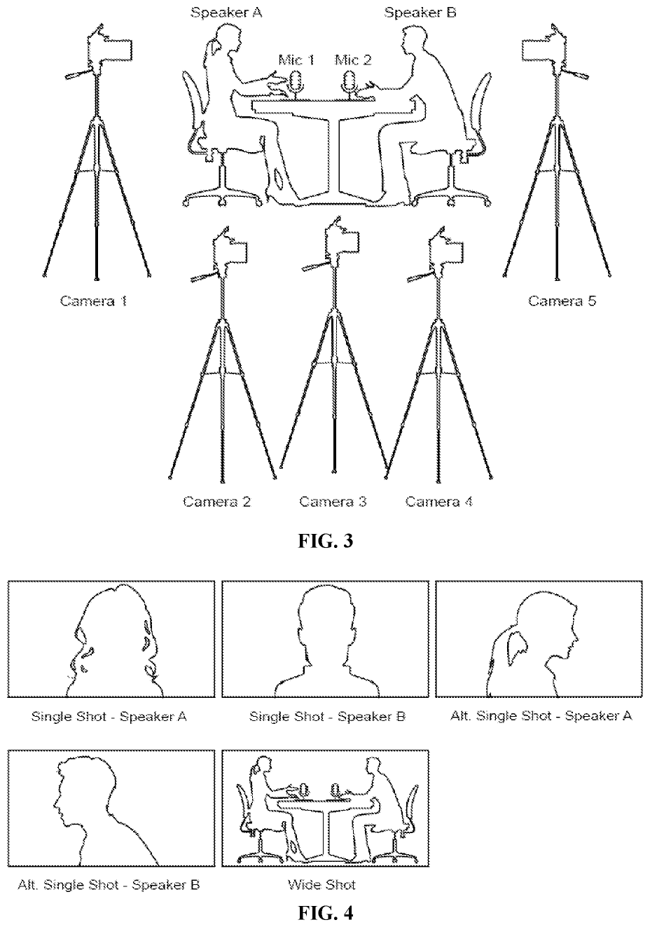

A step 1330, a layout for video sources and audio sources may be determined. The layout may correspond to a classification assigned to a video track and audio sources, thus mapping a layout to each video source. In various setups, a number of video sources may correspond to a number of speakers, but a number of video sources may also exceed or be less than the number of speakers. Likewise, a number of audio sources may correspond to a number of speakers, but a number of audio sources may also exceed or be less than the number of speakers. FIGS. 3-16 illustrate several example setups and layouts.

Referring to FIGS. 3 and 4, a set may involve two speakers. In this example setup, two audio sources in the form of microphones may be provided, one for each speaker. In this example, five video sources in the form of cameras may be provided. In such a configuration, one possible layout for two people may contain two “single shots”, two “alternate single shots”, and one “wide shot” as shown in FIG. 4. Another possible layout in such configuration of video and audio sources may be two “single shots”, one “wide shots”, and two “alternate wide shots”. Of course, other variations are also possible.

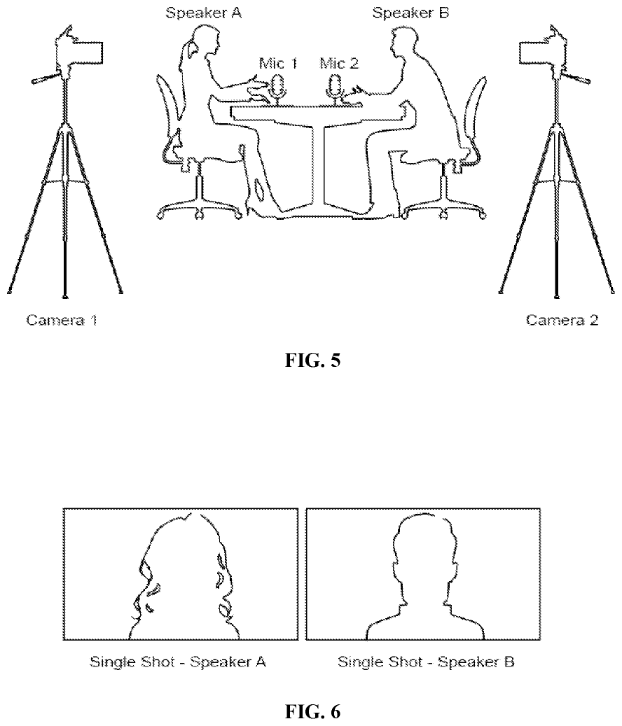

Referring to FIGS. 5 and 6, again, this set may involve two speakers. In this example setup, two audio sources and two video sources may be provided. Here, a possible layout may be two have two “single shots”. Alternatively, another example layout may be a “wide shot” and an “alternate wide shot”.

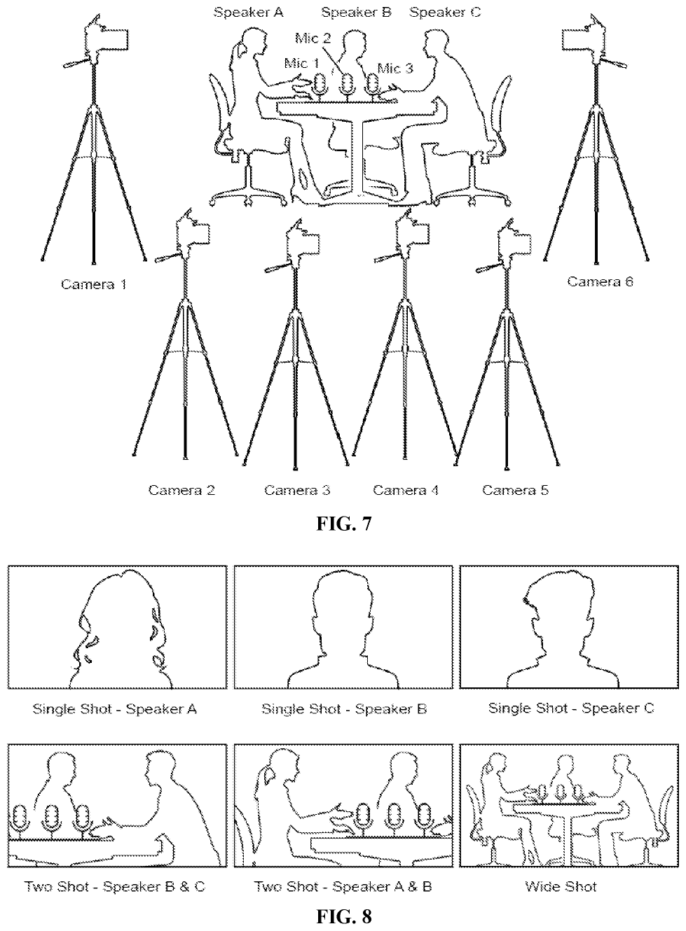

There may be many variations and permutations of layouts depending on a number of video sources and a number of audio sources. Referring to FIGS. 7 and 8, a three-person layout may include three “single shots”, two “two shots”, and one “wide shot”. In another example, a layout for the same setup may include three “single shots”, one “wide shot”, and two “alternate wide shots”.

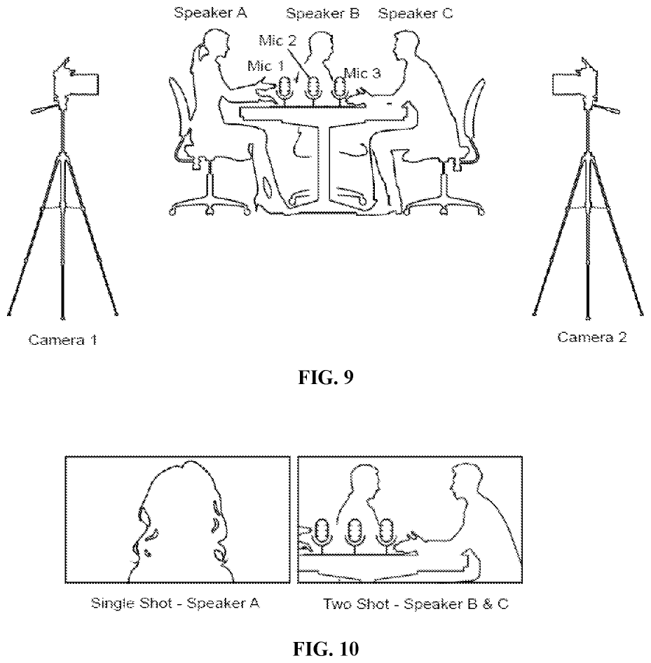

FIGS. 9 and 10 illustrate yet another possible setup for three speakers. In this setup, three audio sources and two video sources may be utilized. In this example, a layout may include a single “single shot” and a “two shot”. Another possible layout may include a “wide shot” and a “two shot” or a “single shot”.

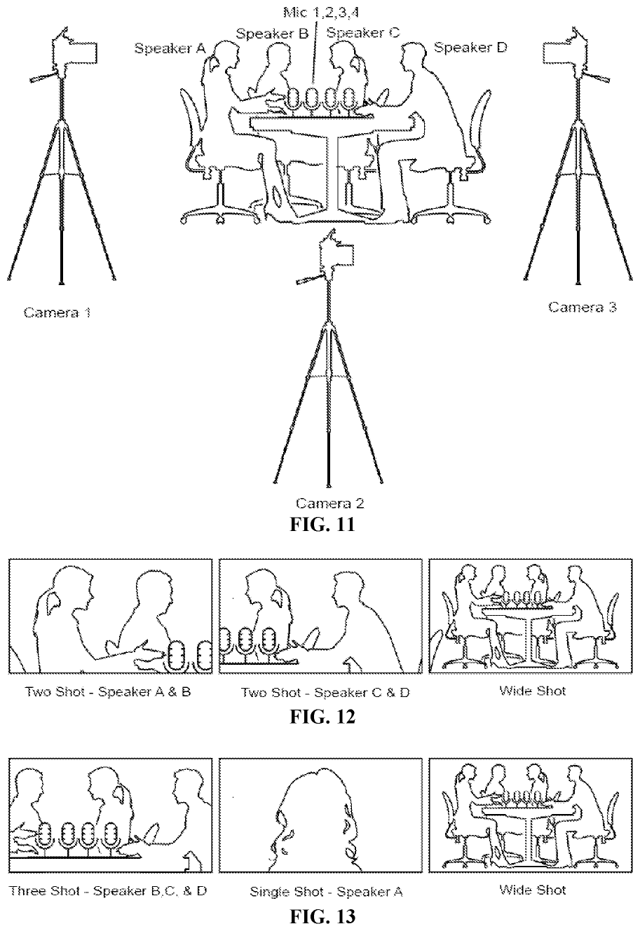

FIGS. 11-13 illustrate another possible setup involving four speakers. In this setup, four audio sources and three video sources may be provided. Some possible layouts include two “two shots” and a “wide shot” as shown in FIG. 12, or a “three shot”, a “single shot”, and a “wide shot” as shown in FIG. 13.

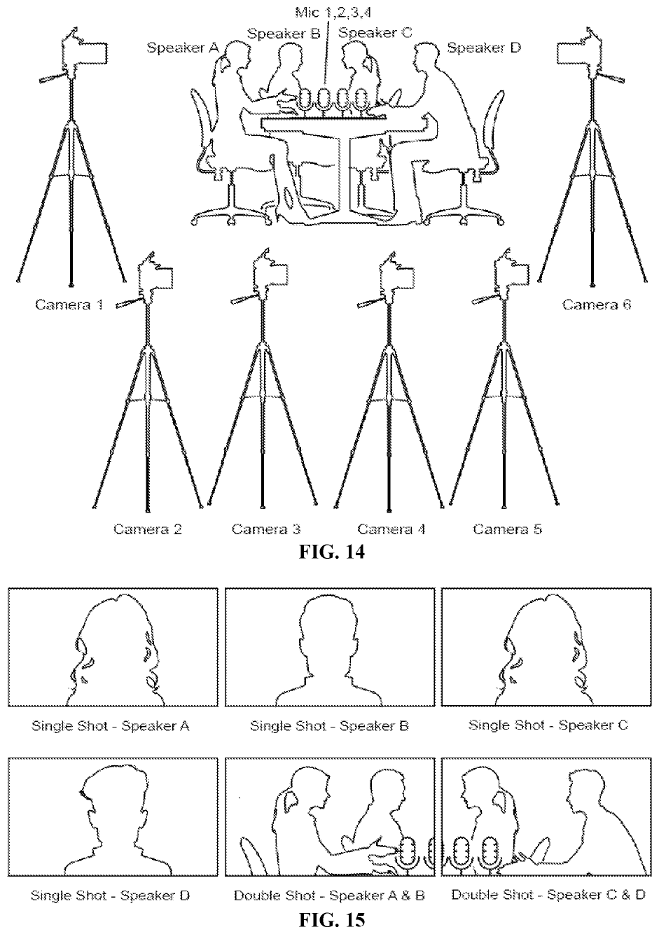

FIGS. 14 and 15 illustrate yet another possible setup involving four speakers. In this setup, four audio sources and six video sources may be provided. Some possible layouts include four “single shots” and two “two shot” as shown in FIG. 15.

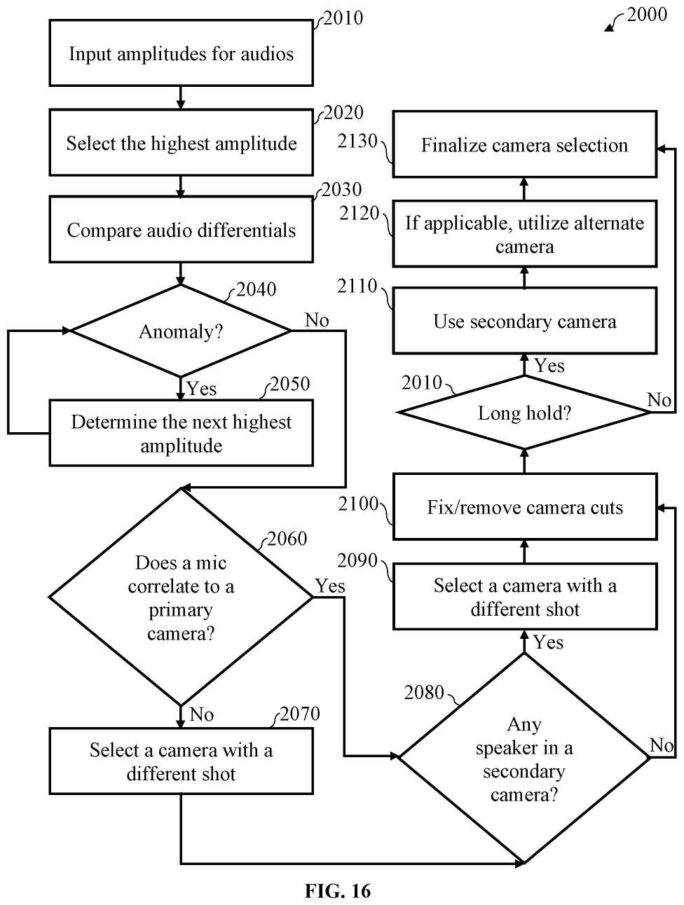

Returning to FIG. 1, a process 1400 may be provided to generate editing instructions. At step 1410, camera selections may be made over a time range. An example camera selection method is shown in FIG. 16.

Referring to FIG. 16, a method 2000 for a camera selection according to an embodiment may include a step 2010, where audio amplitudes information may be inputted. The audio amplitudes may be obtained from the process 1200. Returning to the earlier example of an hour-long video, an audio array thus may contain 36,000 entries at 0.1 second sample rate.

At step 2020, the second array for peak amplitude may be used to identify a targeted speaker, which may be a primary individual to be displayed at a given time in an edit. Using the audio measurements from FIG. 2 as an example, the preliminary targeted speaker for the first time interval may be Speaker A, where, during the first time interval, Speaker A has an audio amplitude of −10 db, which is greater than Speaker B at −30 db, Speaker C at −15 db, or Speaker D −28 db. Step 2020 may be repeated for an entire timeline, so for the given example, 36,000 targeted speaker may be selections.

At step 2030, differentials from the fourth array at step 1240 may be considered. Again using the first time interval in FIG. 2 as an example, Speaker A and Speaker C are within a reasonably close range of 5 db, which may indicate that both individuals are speaking at a same time and volume. A fifth array (or closeness array) indicating close values may be created to flag the closeness. The fifth array may be utilized to decide whether to use “single shots” or potentially to use a “two shot” or “wide shot” that features both Speaker A and Speaker C. Depending on the implementation, the “closeness” may be a threshold value that may be set automatically or be inputted by a user. For example, in some embodiments, within 5 db may be considered “close”. In further embodiments, within 10 db may be considered “close”, and so forth.

At step 2040, anomaly may be identified in an audio amplitude values. Such anomaly may be caused by an unnatural sound like a cough, microphone tap, or other non-verbal sound. In some embodiments, anomaly may be determined by comparing amplitude value between several intervals or adjacent intervals. For example, if, at Tₙ, the amplitude value for a particular audio track is −10 db, but the amplitude values for Tₙ₋₁ and Tₙ₊₁ are around −80 db readings, then Tₙ may be flagged as an anomaly. Depending on the implementation, a threshold value for anomaly may be set automatically or be inputted by a user. For example, in some embodiments, a difference of 20 db in between intervals may be considered an anomaly. In further embodiments, a difference of 50 db may be considered an anomaly, and so forth.

If an anomaly is flagged, at step 2050, a next highest amplitude may be selected as a starting point in lieu of the highest amplitude selected at step 2020. If the next highest amplitude is also determined as an anomaly, the third highest amplitude may be selected as a starting point, and so forth. The selected audio track for each interval over the timeline may be stored as a sixth array (audio track selection array) indicating audio track selections.

At step 2060, selected audio track at each time interval may be associated with a respective primary camera. The primary camera may be that speaker's “single shot”. However, in layouts where a speaker does not have a “single shot”, a camera with a different shot may be selected.

If, at step 2060, no primary camera is selected, at step 2070, the primary camera may be selected based on a camera having the least amount of other speaker in a shot. By way of example, if there is no camera where the speaker is included in a “single shot”, a camera for a “two shot” including the speaker may be used. If there is no “single shot” or “two shot” that includes the speaker, a camera for a “three shot” including the speaker may be used. If all the other shot options have been exhausted, the camera for a “wide shot” may be selected as the primary camera.

Using the layout in FIGS. 9 and 10 as an example, Speakers B and C may use the “two shot” as their primary camera. This is because Speakers B and C do not have an individual single shot available. Similarly, in the layout in FIGS. 11 and 12, all the speakers may have “two shots” as their primary camera. Likewise, in FIGS. 11 and 13, Speakers B, C, and D may have a “three shot” as their primary camera.

Any type of camera classification maybe be used as a primary camera depending on available shot that may include the least speakers, allowing each speaker to get the most possible focus. A seventh array (camera selection array) may be created to indicate a primary camera for each interval over the entire timeline. Thus, the 36,000 audio selection from the sixth array may correspond the 36,000 primary camera selection of the seventh array.

At step 2080, whether any secondary speaker other than a primary speaker is in a secondary camera may be determined. For example, if the primary speaker is in a “two shot” and the other speaker is also talking (as indicated by audio amplitudes), the “two shot” may be selected. Such determination may be based on the second array (peak amplitude array), the fifth array (the closeness array), and/or based on a switching of two or more speakers at a rapid rate (such as within 5 seconds, 3 seconds, or the like). For example, if Speaker A and Speaker B switch back and forth for about ten time intervals and are within about 20% decibel reading, then a two shot of Speaker A and Speaker B may be selected for that time interval. Similarly, the same principle may apply for “three shots”, “four shots”, or more. If two or more of the speakers in these shots are talking back and forth rapidly with similar audio amplitudes, the “three shot” or “four shot” may be selected. Likewise, the same principle may also apply for a “wide shot”. If two or more speakers in a wide shot are talking back and forth with similar audio amplitudes, a “wide shot” may be utilized.

If step 2080 determines that a secondary camera should be used, at step 2090, the secondary camera may be selected, where the seventh array (camera selection array) may be modified to select the secondary camera for applicable time intervals.

At step 20100, the seventh array (camera selection array) may be modified to fix or remove any sudden or jarring camera selections. Quick cuts may be extremely jarring to the viewer. The quick cuts may be based on a threshold that may be set automatically or by the user. For example, any camera selection that are less than a threshold amount (such as 1.0 second) long may be removed. The camera selection prior to the quick cut may be extended to fill in a gap created from removing camera selections that causes the quick cut.

In some embodiments, step 2100 may also include fixing the camera selection to smooth out the edit. For example, a camera selection lasting a certain threshold (such as 1.0 to 1.5 seconds) may be extended by a few more intervals (such as 0.25 to 0.75 seconds) to smooth out the flow of the edit. Similarly, a camera selection lasting a certain threshold (such as 1.5 seconds to 2.5 seconds) may be extended if the adjacent camera selections are not impact significantly, which may be determined by how long the surrounding camera selections are. For instance, if the surrounding camera selections are over a certain threshold (such as about 5 seconds) and the edits does not result in quick cuts, then the camera selection (that lasted 1.5 second to 2.5 seconds) may be extended by 0.25 to 0.75 seconds. However, if the surrounding camera selections are below the threshold, then the in-between camera selection may not be extended.

The exact location of the above cuts may be based on the audio waveforms such as the first array (amplitude array). Specifically, which cut point may provide the smoothest and most precise edit may be determined by finding a dip in the amplitudes from the first array, which may indicate an easier, smoother transition. The precise camera selection adjustments may improve the overall flow of an edit over other editing processes such as post-production edits or live cuts.

At step 2010, the camera selection array may further be analyzed to determine if a camera selection is being held for too long. For example, if a camera selection is used for greater than a threshold value (such as about 20 seconds), the video may become unengaging to the viewer.

If the camera selection is being held for too long, at step 2110, the camera selection array may be modified to use a secondary camera for a portion of a duration of the long hold. In some embodiments, the portion may be about 10% to about 50% of the primary camera selection hold time based on how long the primary camera selection is held. For example, if a primary camera selection is originally being used for about 24 seconds, step 2110 may modify the camera selection such that about 14 seconds may utilize the primary camera selection followed by about 10 seconds of secondary a secondary camera selection. The exact times may be based on a combination of finding a smooth cutoff point on the audio amplitudes and favoring the primary camera.

In another example, at step 2110, if a primary camera selection is being used for about 55 seconds, a correction may include about 17 seconds of primary camera selection followed by about 11 seconds of secondary camera selection followed by another about 17 seconds of primary camera selection. The camera selection may be alternated however many times necessary so as to not exceed (or greatly exceed within a range) that of the long hold threshold. Once the long hold is eliminated, the camera selection array may be modified to reflect the new selection.

At step 2120, “alternate” camera shots may be utilized where applicable. Some layouts may not have any “alternate” shots, thus there would be no applicable edits. In layouts that include alternate shots, a portion of the original shots may be modified to “alternate” angles. For example, if a layout includes a “three shot” and an “alternate three shot”, the entire camera selection array may be looped through to utilize the “alternate” angle intermittently. In such a scenario, where a “three shot” is selected over several discrete intervals (such as between Tₙ to Tₙ₊₆ and Tₙ₊₂₀ to Tₙ₊₃₀), the camera selection array may be modified such that Tₙ to Tₙ₊₆ utilizes the “three shot” and Tₙ₊₂₀ to Tₙ₊₃₀ utilizes the “alternate three shot” and so forth.

At step 2130, the camera selection array may be finalized. Returning to the method 1000 in FIG. 1, step 1420 may convert the camera selections into editing instructions. The editing instructions may inform editing software (such as Adobe Premiere Pro, DaVinci Resolve, Final Cut Pro X, Runway, or any comparable desktop, mobile, or cloud-based video editor) to create cuts at the times and show the correct camera layer for each time interval.

At step 1430, frame rates and sequence settings may be accounted to ensure that the method 1000 can be executed without regard to resolution, aspect ratio, color space, audio sample rate, codec, timecodes, or other sequence settings. For example, if the frame rate is drop frame (such as 23.976, 29.97, or 59.99), the step 1430 may verify that cuts are still taking place at the appropriate location.

At step 1500, once the editing instructions have been created, the editing instructions may be executed through a software program. The editing instructions may be executed with a number of common editing techniques for multi-camera editing. An editing option may be to remove portions of unused video by cutting and deleting the unused portions. Another editing option may be to disable the unused portions. Yet another editing option may be to feed editing instructions to a multi-camera sequence.

Once the editing instructions have been executed, at step 1600, the edited multi-camera video may be completed, which may be outputted, exported, displayed, or otherwise utilized as suitable.

Through using audio and video analysis that results in camera selection array, the embodiments in this disclosure utilizes a “scientific” or “technical” way to edit multi-camera videos, which have previously been done by human feelings and gut instinct. The resulting video that has been edited through the methods and processes described herein may exceed the results from other known editing methods. Specifically, videos as edited herein may be much smoother and more precisely edited. In contrast, known methods such as “post-production” and “live cutting” may result in mistakes and miss an active speaker for a significant portion of the time. Moreover, other known methods may result in a less precisely finished product. Put differently, the methods and processes disclosed herein are scientifically based that are different than human-based methods of editing and are not automations of known processes. Thus, embodiments herein can achieve a better editing results and efficiency than other known processes.

Specific embodiments of a post-capture multi-camera editor according to the present disclosure have been described for the purpose of illustrating the manner in which the disclosure can be made and used. It should be understood that the implementation of other variations and modifications of this disclosure and its different aspects will be apparent to one skilled in the art, and that this disclosure is not limited by the specific embodiments described. Features described in one embodiment can be implemented in other embodiments. The subject disclosure is understood to encompass the present disclosure and any and all modifications, variations, or equivalents that fall within the spirit and scope of the basic underlying principles disclosed and claimed herein.

What is claimed is:

1. A method for editing a multi-camera video comprising:
measuring an amplitude over a time interval for each of a plurality of audio tracks;
assigning a classification to each of one or more cameras;
selecting a first camera from the one or more cameras based on the classification assigned to each of the one or more cameras and the amplitude of a plurality of audio track; and
generating a video such that the video is cut based on the camera selection,
wherein each of the plurality of audio tracks corresponds to one of a plurality of audio sources respectively, and each of the one or more cameras corresponds to at least one of the plurality of audio sources.

2. The method of claim 1, wherein the selecting the first camera further comprising:
determining a largest amplitude at the time interval among the plurality of audio tracks; and
selecting a first audio track from the plurality of audio tracks wherein the first audio track includes the largest amplitude at the time interval, and wherein the first camera corresponds to the first audio track.

3. The method of claim 2 further comprising:
determining that the first audio track at the time interval includes an anomaly; and
selecting a second audio track from the plurality of audio tracks wherein the second audio track includes a next largest amplitude at the time interval, and wherein the first camera corresponds to the second audio track.

4. The method of claim 3, wherein the determining that the first audio track includes the anomaly further comprising comparing a first amplitude for the first audio track at the time interval against a second amplitude for the first audio track at an adjacent time interval.

5. The method of claim 2 further comprising:
selecting the first camera based on a hierarchy of how many individuals are captured by the first camera during the time interval.

6. The method of claim 1 further comprising:
determining an amplitude differential between two of the plurality of audio tracks at the time interval is within a first threshold,
wherein the selecting the first camera further comprising selecting the first camera that correspond to both of the two of the plurality of audio tracks.

7. The method of claim 1 further comprising converting the selecting of the first camera into an editing instruction for the video.

8. The method of claim 1, wherein the classification corresponds to an amount of audio tracks that each of the one or more cameras correspond to.

9. A method for editing a multi-camera video comprising:
measuring an amplitude per time interval for each of a plurality of audio tracks over a length of a video;
determining a first peak audio amplitude among the plurality of audio tracks for each time interval;
creating a first array including the first peak audio amplitude among the plurality of audio tracks for each time interval;
creating a second array including a camera selection for each time interval based on the first array; and
generating the video such that the video is edited based on the second array.

10. The method of claim 9 further comprising:
determining the first peak audio amplitude among the plurality of audio tracks at a time interval is an anomaly; and
modifying the first array such that the first peak audio amplitude is replaced with a second peak audio amplitude at the time interval.

11. The method of claim 10, wherein the determining that the first peak audio amplitude is the anomaly further comprising comparing the first peak amplitude at the time interval against a second amplitude for a same audio track at an adjacent time interval.

12. The method of claim 9, wherein the camera selected is further based on a hierarchy of how many individuals are captured by a camera during the time interval.

13. The method of claim 9 further comprising:
determining an amplitude differential between two of the plurality of audio tracks for each time interval;
creating a third array for the amplitude differential; and
modifying the second array based on the third array.

14. The method of claim 9 further comprising:
determining whether the second array includes two over more different camera selections within a threshold period; and
modifying the second array to extend a camera selection at a beginning of the threshold period throughout the threshold period by discarding other camera selections within the threshold period.

15. The method of claim 9 further comprising:
determining whether the second array includes a first camera selection for a time period that exceeds a threshold amount; and
modifying the second array to include a second camera selection different during the time period, wherein the second camera selection is different than the first camera selection.

16. The method of claim 9 further comprising:
determining whether a first camera selection is utilized for a first time period and a second time period and whether an alternate camera selection is available to the first camera selection; and
modifying the second array to include the alternate camera selection in lieu of the first camera selection for the second time period.

17. The method of claim 16, wherein the first camera selection and the alternate camera selection both include a same number of individuals captured by a camera.

18. The method of claim 9 further comprising converting the second array into an editing instruction for the video.

19. The method of claim 9 further comprising assigning a classification to each of one or more video tracks, wherein the classification corresponds to an amount of audio tracks that each of the one or more video tracks correspond to.

20. The method of claim 19, wherein the camera selection for each time interval comprises a selection of a video track from the one or more video tracks for each time interval.
